(19) United States
(12) Patent Application Publication
(10) Pub. No.: US 2007/0258422 A1
(43) Pub. Date: Nov. 8, 2007

(54) QUALITY OF SERVICE CONTROL FOR A DATA TRANSMISSION IN A WIRELESS COMUNICATION NETWORK USING CONFIGURATION MESSAGES

(75) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,814

(22) PCT Filed: May 11, 2005
(86) PCT No.: PCT/IB05/51538

§ 371 Date: Nov. 8, 2006

(30) Foreign Application Priority Data
May 13, 2004 (EP) 04102076.9

(51) Int. Cl. H04L 12/56

(52) U.S. Cl. 370/338

(57) ABSTRACT

In UMTS, quality of service attributes, which a user equipment can prescribe for an end-to-end service to be set up in order to meet a specific quality of service, in most cases have to be processed by a central call and admission control function in the network. These quality of service attributes have to be made known to the admission functions of all possible path-segments. Advantageously, according to an exemplary embodiment of the present invention, a quality of service attribute is only transmitted to a selected number of network nodes at the edge of the network. The selected and limited number of network nodes perform a quality of service operation triggered by a receiving station. Advantageously, this may result in a reduction of data traffic and an improved implementation and standardization process. Furthermore, the quality of service attribute may be added to an obligatory configuration message, thus even further reducing the data traffic.

The present invention relates to the field of data transmission. In particular, the present invention relates to a method for performing a quality of service control for a data transmission from a transmitting station to a receiving station in a network, to a method of transmitting a first quality of service attribute corresponding to a first quality of service operation for a data transmission from a transmitting station to a receiving station in a network, to communication systems, receiving stations and software programs for performing a quality of service control for a data transmission and for performing a transmission of a first quality of service attribute corresponding to a first quality of service operation for a data transmission, transmitting station to a receiving station in a network.

In UMTS, there are quality of service attributes (QOSA) which a user equipment (UE) can prescribe for an end-to-end service to be set up in order to meet a specific quality of service. These quality of service attributes have to be processed by a central call and admission control function (CACF) in the network. If they can be met in all path-segments, provisions are made in the affected network nodes to meet them.

A standardized network is usually a growing system, which develops and is augmented over time. By performing the known quality of service management, any quality of service attribute which is introduced later on in the standardization process would have to be made known to the admission control functions of all possible path-segments, i.e. on all network levels. Such an approach is expensive both in terms of the standardization process, i.e. many working groups have to be involved, and in terms of the implementation, i.e. many different network node types are affected.

It is an object of the present invention to provide for an improved quality of service control.

According to an exemplary embodiment of the present invention as set forth in claim 1, the above object may be solved by a method of performing a quality of service control for a data transmission from a transmitting station to a receiving station in a network, the network comprising a plurality of network nodes. A first quality of service attribute and a first configuration message are transmitted from the receiving station to at least one selected first network node of the plurality of network nodes during a configuration procedure and a first quality of service operation is performed by one second network node of the plurality of network nodes on the basis of the first quality of service attribute received in the at least one selected first network node. Furthermore, the first configuration message comprises the first quality of service attribute.

For example, a quality of service attribute may be signalled to a first network node, which may be located at the network edge, without involving other network nodes. In a second step, a first quality of service operation may be performed by a second network node. The second network node may be the first network node or any other network node and the quality of service operation may be based on the transmitted quality of service attribute.

Advantageously, since no further network nodes or admission control functions (in UMTS) are involved, this may allow for a simplified network implementation and an improved quality of service control.

Furthermore, this may provide a simple means for incorporating a quality of service attribute into the quality of service architecture such that a minimum of network nodes have to deal with this attribute, by adding the quality of service attribute to a configuration message, which has to be exchanged between the receiving station and the at least one first network node. Furthermore, this may allow for a reduced signalling data traffic.

According to another exemplary embodiment of the present invention as set forth in claim 2, the network comprises a plurality of logical channels and the data is transmitted as data packet. Furthermore, the data packet is transmitted via at least one first logical channel of the plurality of logical channels and the first quality of service attribute comprises an identification of a group of second logical channels of the plurality of logical channels. Furthermore, the first quality of service attribute is applied to the group of second logical channels in form of the first quality of service operation performed by the second network node.

Advantageously, this may allow for a quality of service control on the basis of a channel flow control for the group of second logical channels.

According to another exemplary embodiment of the present invention as set forth in claim 3, the first quality of service operation is triggered by a command transmitted from the receiving station to at least one of the first and second network nodes.

Advantageously, this may allow for a control or triggering of the quality of service operation, such as, for example, a flow control of data transmission, by the receiving station.

Another exemplary embodiment of the present invention is set forth in claim 4, wherein the first quality of service attribute corresponds to a request for flow control of the data packet transmission.

According to another exemplary embodiment of the present invention as set forth in claim 5, the at least one first network node performs a second quality of service operation on the basis of the first quality of service attribute before the first quality of service operation is performed by the second network node.

Advantageously, this may allow the first network node to respond to the first quality of service attribute before a response of the second network node in form of the first quality of service operation is performed.

According to another exemplary embodiment of the present invention as set forth in claim 6, the second quality of service operation comprises a tagging of the data packet, by the at least one first network node, if the data packet is transmitted via a second logical channel of the group of second logical channels. Furthermore, the first quality of service operation performed by the second network node comprises a blocking of the tagged data packet.

Therefore, according to this exemplary embodiment of the present invention, the second network node is made aware of the data packets, which should not be sent after a trigger command is transmitted from the receiving station to the second network node.

According to another exemplary embodiment of the present invention as set forth in claim 7, the second quality of service operation performed by the at least one first network node comprises a transmission of a second quality of service attribute on the basis of the first quality of service attribute from the first network node to the second network node, wherein the second quality of service attribute comprises the identification of the group of second logical channels of the plurality of logical channels. The first quality of service operation is performed by the second network node and comprises a blocking of the data packet, if the data packet is transmitted via a second logical channel of the group of second logical channels.

Advantageously, according to this exemplary embodiment of the present invention, based on the list of logical channels to throttle, the second network node can then avoid sending data packets of these logical channels when it receives a STOP command from the receiving station.

Advantageously, this may allow for an efficient implementation of the signalling means to add the quality of service attribute “Flow Control” for the logical channels of the group of logical channels, and enforce flow control of these logical channels, after a STOP command was received from the receiving station.

According to another exemplary embodiment of the present invention as set forth in claim 8, the at least one first network node transmits a second configuration message to the second network node during a second configuration procedure and the second configuration message comprises the second quality of service attribute.

Thus, by adding the second quality of service attribute to an obligatory second configuration message, the signalling data traffic may be further reduced.

According to another exemplary embodiment of the present invention as set forth in claim 9, the method is applied for data transmission via the High Speed Downlink Shared Channel in UMTS.

This may provide for a simple way of introducing the necessary signalling means to provide flow control for data transmission on radio bearers mapped to the HS-DSCH without modifying the quality of service architecture of UMTS and thus involving only the absolute minimum of network nodes for the addition of the quality of service attribute “flow control” to radio bearers mapped to the HS-DSCH.

Another exemplary embodiment of the present invention is set forth in claim 10, wherein a method of transmitting a first quality of service attribute corresponding to a first quality of service operation for a data transmission from a transmitting station to a receiving station in a network is set forth, wherein the network comprises a plurality of network nodes. The method comprises the steps of transmitting a first configuration message from the receiving station to at least one selected first network node of the plurality of network nodes during a configuration procedure, wherein the first configuration message comprises the first quality of service attribute corresponding to a first quality of service operation by one second network node of the plurality of network nodes.

Advantageously, this may allow for the introduction of further quality of service attributes without changing the quality of service architecture of the network and with a minimum of changes to the signalling messages exchanged between network nodes and between the user equipment and network nodes, and hence for an improved quality of service control with reduced signalling data traffic.

According to another exemplary embodiment of the present invention as set forth in claim 11, the at least one selected first network node transmits a second configuration message to the second network node during a second configuration procedure and the second configuration message comprises a second quality of service attribute.

Advantageously, this may further reduce the signalling data traffic.

According to other exemplary embodiments of the present invention as set forth in claims 12 and 13, a communication systems for performing a quality of service control for a data transmission from a transmitting station to a receiving station in a network are provided, wherein the network comprises a plurality of network nodes. According to the exemplary embodiment of the present invention as set forth in claim 12, the receiving station is adapted for transmitting a first quality of service attribute to at least one selected first network node of the plurality of network nodes. Furthermore, one second network node of the plurality of network nodes is adapted for performing a first quality of service operation on the basis of the first quality of service attribute received in the at least one selected first network node. According to the exemplary embodiment of the present invention as set forth in claim 13, the receiving station is adapted for transmitting a first configuration message to at least one selected first network node of the plurality of network nodes during a configuration procedure, wherein the first configuration message comprises the first quality of service attribute corresponding to a first quality of service operation by one second network node of the plurality of network nodes.

Advantageously, this may provide for an improved quality of service control in a communication system with a minimum of changes to the signalling messages exchanged between the network nodes and between the terminals and the network nodes.

According to another exemplary embodiment of the present invention as set forth in claim 14, a receiving station for a communication system is provided for performing a quality of service control for a data transmission from a transmitting station to the receiving station in a network, the network comprising a plurality of network nodes, wherein the receiving station is adapted for transmitting a first quality of service attribute to at least one selected first network node of the plurality of network nodes. Furthermore, one second network node of the plurality of network nodes is adapted for performing a first quality of service operation on the basis of the first quality of service attribute received in the first network node.

Furthermore, according to another exemplary embodiment of the present invention as set forth in claim 15, a receiving station for a communication system is provided, wherein the receiving station is adapted for transmitting a first configuration message to at least one selected first network node of the plurality of network nodes during a configuration procedure, wherein the first configuration message comprises the first quality of service attribute corresponding to a first quality of service operation by one second network node of the plurality of network nodes.

Advantageously, this may allow for an improved quality of service control with a reduced signalling data traffic.

The present invention also relates to computer programs, which may, for example, be executed on a processor. Such computer programs may be part of, for example, a communication system for performing a quality of service control or a data transmission in a network. The computer programs according to an exemplary embodiment of the present invention are set forth in claims 16 and 17. These computer programs may be preferably loaded into working memories of data processors. The data processors are thus equipped to carry out exemplary embodiments of the methods of the present invention. The computer programs may be stored on a computer readable medium, such as a CD-ROM. The computer programs may also be presented over a network such as the WorldWideWeb, and may be downloaded into the working memory of a data processor from such networks. Such programs may be written in any suitable programming language, such as C++.

It may be seen as the gist of an exemplary embodiment of the present invention that a quality of service attribute is only transmitted to a selected number of network nodes at the edge of the network, e.g. to the radio bearer service in UMTS. The selected (and limited) number of network nodes perform a quality of service operation which has been triggered by a receiving station. Therefore, a quality of service attribute is not transmitted to the admission control functions of all possible path-segments, i.e. on all network levels. Advantageously, this may result in less signalling data traffic and in an simplified implementation, since less different network node types are affected, as well as in an improved standardization process, since fewer standardisation working groups have to be involved. Advantageously, according to an exemplary embodiment of the present invention, a quality of service attribute may be added to an obligatory configuration message, thus even further reducing the signalling data traffic.

These and other aspects of the present invention will become apparent from and elucidated with reference to the embodiments described hereinafter.

Exemplary embodiments of the present invention will be described in the following, with reference to the following drawings:

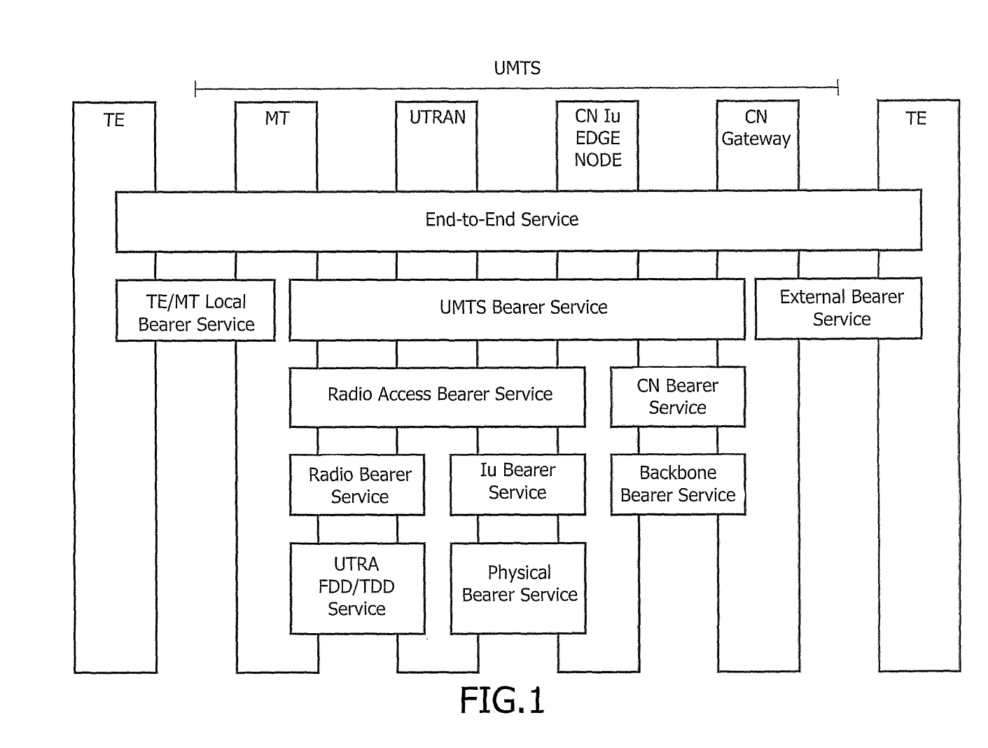

FIG. 1 shows a simplified schematic representation of an UMTS quality of service architecture.

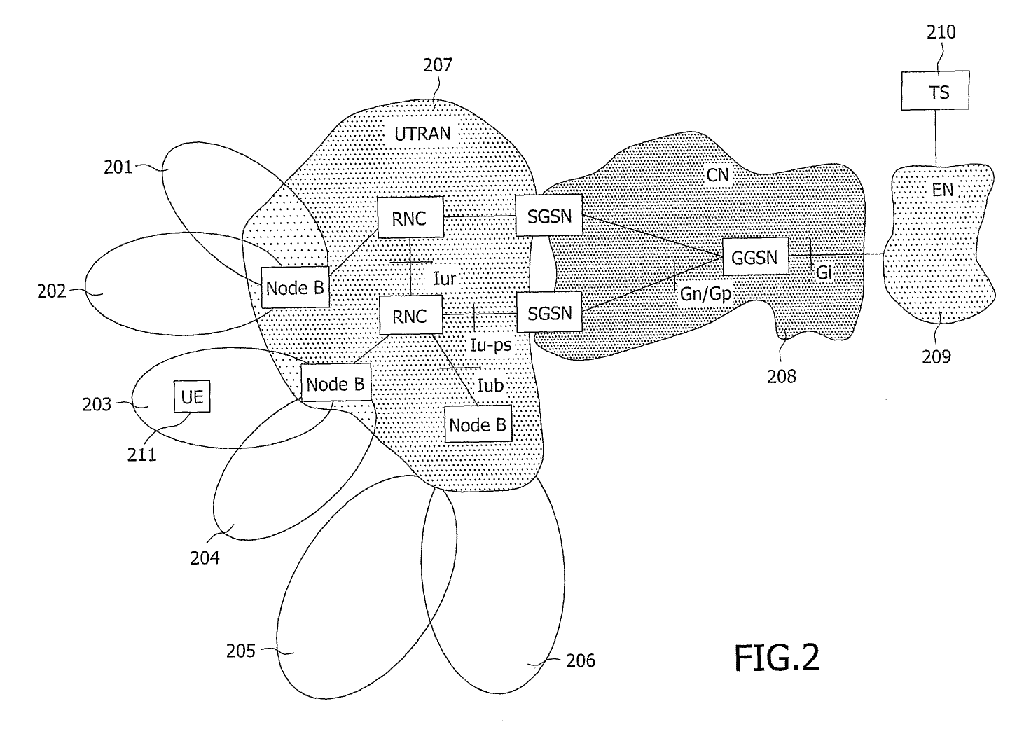

FIG. 2 shows a schematic representation of a network architecture comprising network nodes.

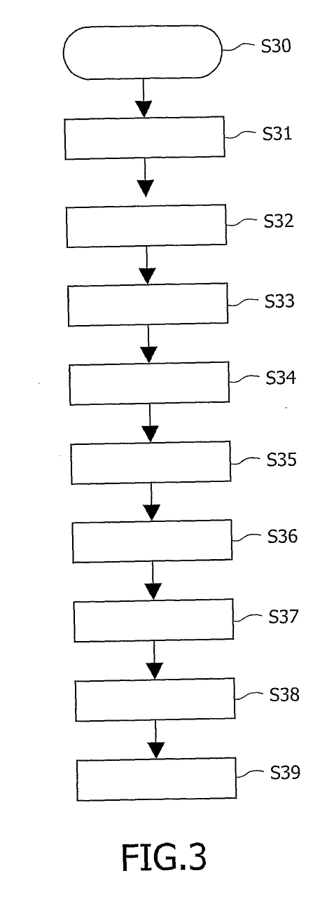

FIG. 3 shows a flow-chart for establishing an end-to-end service between a receiving station and a transmitting station in a UMTS network.

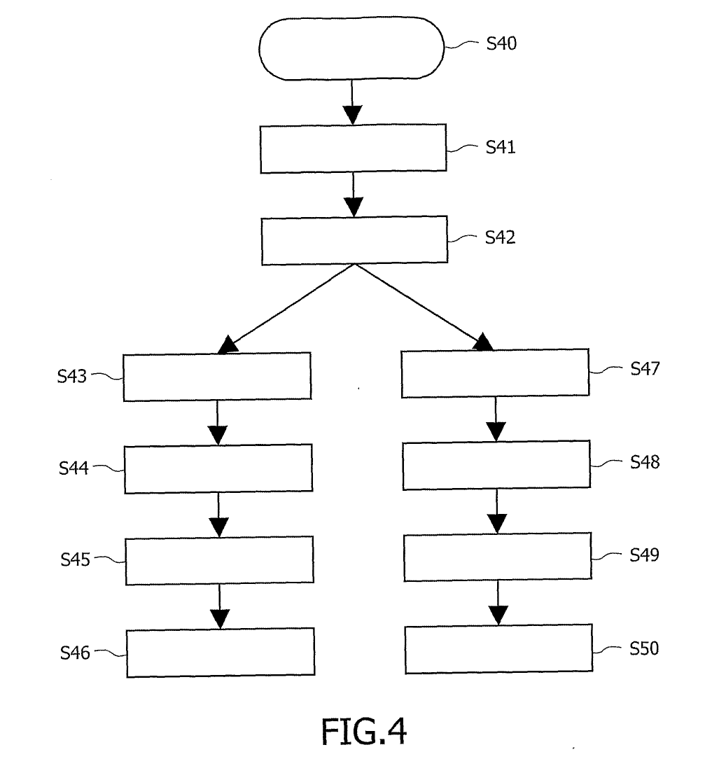

FIG. 4 shows a flow-chart depicting a configuration of the receiving station by UTRAN and performing a quality of service control for a download of data from a transmitting station to a receiving station.

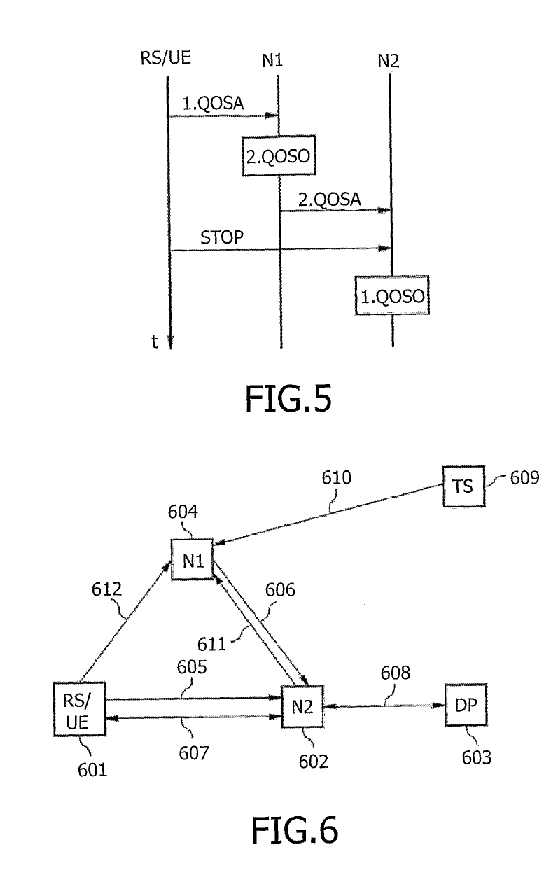

FIG. 5 shows an exemplary embodiment of a method according to the present invention.

FIG. 6 shows an exemplary embodiment of a communication system including a data processing device according to the present invention for executing an exemplary embodiment of a method in accordance with the present invention.

FIG. 1 shows a schematic representation of a UMTS quality of service architecture. In UMTS, quality of service of the end-to-end service is determined by the “underlying” services, which are provided by the different layers of the network, which may be looked upon as resulting from the grouping of functions in different nodes of the network, which provides the end-to-end service between a mobile terminal, e.g. a mobile phone, a smart phone, a laptop with UMTS data card, etc., and an end-point reachable via the network, which end-point could also be a mobile terminal, a fixed terminal, or even a server, which is connected to the network.

According to the quality of service architecture defined in “TS23.107 3rd Generation Partnership Project; Technical Specification Group Services and System Aspects; Quality of Service (QoS) concept and architecture”, which is hereby incorporated by reference, the end-to-end service bases on:
1. The UMTS Bearer Service between the mobile terminal (MT) and the Core Network (CN) Gateway;
1.1. The Radio Access Bearer Service between the mobile terminal and the core network Edge Node connected to the UTRAN (UMTS Terrestrial Radio Access Network) via the Iu interface (Core Network Iu Edge Node);
1.2. The Core Network Bearer Service between the Core Network Iu Edge Node and the Core Network Gateway;
1.2.1. The Radio Bearer Service between the mobile terminal and the UTRAN;
1.2.2. The Iu bearer service between the UTRAN and the Core Network Iu Edge Node;
1.2.3. The Back Bone Bearer Service between the Core Network Iu Edge Node and the Core Network Gateway;
1.2.3.1. UTRA FDD/TDD service between the mobile terminal and the UTRAN;
1.2.3.2. Physical Bearer Service between UTRAN and the Core Network Iu Edge Node.

According to FIG. 1, the UMTS quality of service architecture distinguishes between terminal equipment and a mobile terminal. It is the terminal equipment (TE), which can access a service, via a mobile terminal in order to communicate with any other terminal equipment.

In terms of network nodes, the different services, which the end-to-end service needs, can be described in more detail as follows from the network node architecture of network, which provides this end-to-end service, in FIG. 2, where the user equipment (UE) represents mobile terminal and terminal equipment together. FIG. 2 shows the network architecture for the case of a packet switched service. A similar model holds for the circuit-switched service.

The network depicted in FIG. 2 comprises a plurality of radio cells 201, 202, 203, 204, 205, 206, comprising the UEs 211, and different network nodes, such as different NodeBs (which link the UTRAN 207 to the radio cells), RNCs, SGSNs and GGSN nodes. NodeB and RNC, which are part of the UTRAN, are linked via the Iub interface. RNC and SGSN (which links the UTRAN to the CN 208) are linked via the Iu-ps interface. SGSN and GGSN, which is part of the CN 208, are linked via the Gn/Gp interface. Furthermore, the GGSN is linked to an external network 209 via the Gi interface, which may be linked to a server or transmitting station 210.

The UMTS bearer service is between the GGSN (Gateway GPRS Support Node) and the user equipment, the Radio Access Bearer Service is between the SGSN and the user equipment, the Radio Bearer Service is between RNC (Radio Network Controller) and the user equipment. The Radio Bearer Service is then mapped to the UTRA FDD/TDD service provided by the air interface between the NodeB and the user equipment (see FIG. 1).

A quality of service (QOS) of the end-to-end service (between, e.g., a UE and a server) is determined by the QOS of the services, which build up the end-to-end service. For example, the end-to-end delay may only be about 200 ms, if the underlying services can make sure that the delay on the corresponding segments of the path through the network does not add to more than essentially 200 ms. Similarly, a packet loss probability of, for example, 0.1% across the whole path can only be guaranteed, if the segments of the path can provide a sufficiently low loss probability.

When asking for an end-to-end service, the user equipment intends a special QOS, and conveys the corresponding QOS attributes to the network. The admission control function of the network has to check, whether on all segments of the path used by the end-to-end service, the requested QOS may be ensured.

Hence, in this model, QOS is managed by a unique control entity, which collects from the admission control functions of the different path-segments, whether the requested QOS can be ensured or not. This model implicitly assumes that possible QOS parameters are known by the central control entity, which then forwards them to the admission control functions of the affected path-segments in order to check, whether the requested QOS parameters can be met.

A standardized network is usually a growing system, which develops and is augmented over time. With the above model of QOS management, any QOS attribute, which is introduced later on in the standardization process, would have to be made known to the admission control functions of all possible path-segments, i.e. on all network levels. Such an approach is expensive both in terms of the standardization process (i.e. many working groups have to be involved) and in terms of the implementation (i.e. many different network node types are affected).

In some cases, however, this costly approach can be circumvented, at least if the QOS attributes refer to the network edge or to network nodes at the edge of the network, e.g. to the radio bearer service, which is described in the following based on the quality of service attribute “flow control” on the high speed downlink shared channel (HS-DSCH).

A user equipment can be configured to receive, in the downlink, data via the HS-DSCH, which provides a significantly higher data rate than the dedicated channel (DCH). The HS-DSCH allows for peak data rates in the range of 10 Mbps, while the peak data rate on a DCH cannot exceed 2 Mbps, but is usually much lower. The HS-DSCH is typically used for packet data transmission, for example streaming data. While packet data transmission is controlled and scheduled by the SRNC in case of the DCH, it is the NodeB, which schedules data transmission for the HS-DSCH.

Scheduling of data transmission should naturally take into account the current buffer status on the receiving side, i.e. here of the user equipment, in order to avoid that data packets are transmitted, which can no longer be stored in the user equipment and have to be discarded. In this case, valuable radio resources are wasted. Since the SRNC runs a radio link control protocol, which implements a retransmission protocol based on a window mechanism, where the sending entity is allowed to send as many PDUs (packet data units) without waiting for an acknowledgement, is given by the size of the window, this window mechanism can also be used for flow control, so that the stream of packets can be throttled by means of messages sent from the receiving side (here the user equipment), if memory runs short.

However, due to the different location of the scheduling function in case of the HS-DSCH, as well as because of the much higher data rate available on the HS-DSCH, this RLC-based flow-control is much too inert so that it would (at least) not fully avoid wasting downlink resources. However, flow-control may be introduced based on a special uplink STOP command rather than a window based flow-control mechanism: As soon as the user equipment finds out that it runs short of memory for storing a packet received via a logical channel mapped to the HS-DSCH, it sends this STOP command, which is received by the NodeB and interpreted in the sense that for a pre-defined time, no further packets should be sent on the HS-DSCH via this logical channel.

The problem now is to find a simple way for including this additional QOS attribute “flow-control and using the HS-DSCH” into the quality of service architecture in such a way that a minimum number of network nodes have to deal with this quality of service attribute in order to give the user the choice to ask for an end-to-end service, which uses, over the air interface, the HS-DSCH with flow-control. As a consequence, also the standardization effort is minimized.

According to the present invention, a simple means is provided for incorporating a quality of service attribute into the quality of service architecture such that a minimum of network nodes have to deal with this attribute. This technique may apply, for example, if there are configuration messages, which are exchanged between the user equipment and a network node, which has to get notice of the respective quality of service attribute.

It should be noted that, according to the present invention, a configuration message may be a message, which a network node sends to the user equipment in order to assign network resources, e.g. channelization code or scrambling code, and sending such a configuration message causes the user equipment to send, in reply, another configuration message, by which the user equipment confirms that it configured itself in such a way that the assigned network resources can be used for data transmission between the user equipment and the network. E.g. in UMTS, the RNC would send a RADIO BEARER RECONFIGURATION message to a UE in order to allocate a radio bearer for data transmission or for modifying an already established radio bearer for data transmission, and the UE would reply to this with a RADIO BEARER RECONFIGURATION COMPLETE message, by which it indicates that it has configured itself in such a way that data can be transmitted via the new or modified radio bearer.

Configuration messages have to be distinguished from Call Control messages, which a UE sends to the network in order to request a service, e.g. a voice call, or which the UE receives from the network in order to be asked to accept an incoming service request, e.g. a voice call initiated by another terminal equipment somewhere else in the network (which could also be another UE). State-of-the-art Call Control messages used to request a service usually contain quality of service attributes.

These Call Control messages entail the transmission of configuration messages, by which the resources are assigned, which are needed to support the service.

According to an exemplary embodiment, this problem may be solved as schematically depicted in FIG. 3. FIG. 3 shows a flow-chart of an exemplary embodiment of the method according to the present invention for configuring “the HS-DSCH with flow-control”:

The method starts at step S30 in which a user decides, that he wants to download streaming data, such as a piece of music, for example, to his Hifi-system or walkman, which only has a blue Bluetooth interface. The data is only available via the UMTS service provider. Hence, the streaming data download is done by means of the users UMTS-UE, which apart from the UMTS air-interface also has a Bluetooth interface and thus can forward the streaming data to the Hifi-system. In order to make the download fast, the user intends to configure the downlink connection to the UMTS network such that the download data is sent via the HS-DSCH. Since charging is based on the amount of data sent via the air interface, the user wants to have flow-control applied in order to avoid that he has to pay for packets, which are sent over the air interface but may have to be discarded in the user equipment, since the user equipment runs out of memory due to a temporary bottleneck on the Bluetooth interface.

In order to eventually start the download, the user may first configure his user equipment in such a way, that the data which it is going to download from the server is forwarded to the target device, for example, the Hifi-system, which could mean, for example, “mounting” from his user equipment a drive on the target device reachable via the Bluetooth connection, so that the data is later on copied to the target device. This is performed in step S31.

Furthermore, the user has to set up a connection to the music server reachable via the UMTS network, where he finds the desired piece of music, and for this connection he has to select the “High-Speed”-option, so that the data is downloaded via the HS-DSCH. Furthermore, the user may choose the option “with flow-control”. The option “HS-DSCH with flow-control” is then stored in the RRC (Radio Resource Control) layer of the user equipment. The Radio Resource Control layer is in charge of replying to so-called RRC messages, by which the UTRAN configures the user equipment for, for example, receiving data via the HS-DSCH with its own RRC messages. This configuration step would be done by means of a local control primitive, by means of which the RRC layer can be configured by the higher layers (step S32).

The connection set up is now done in several steps:

The user equipment sets up a so-called RRC connection to the next reachable radio network controller, which becomes its serving RNC (SRNC) (step S33).

Then, in step S34, the user equipment sends by means of the RRC connection a CM_SERV_REQ message to the network in order to request the end-to-end service to the server. Then, in step S35, the network initiates the authentication process, based on the well-known “challenge-response” scheme for the user equipment, i.e. the network sends a random number, from which the user equipment computes—using a secret key only known to this particular user equipment and the network—a number RES, and sends RES to the network, which considers the user equipment to be authenticated, if the received value RES equals the expected value RES, which the network can also compute from the random number and the secret key.

After successful authentication, the network starts ciphering and integrity protection between the user equipment and the SRNC (step S36) and, in step S37, the user equipment sends a SETUP message to the network in order to set up the end-to-end service. In step S38, the network replies with a CALL_PROCEEDING message, by which the end-to-end service is then established.

Up to this point, the user equipment may send and receive data only via the common transport channels provided by the air interface and which are usually available without any configuration procedure run by the UTRAN, i.e. sending configuration messages from the SRNC. In step S39 then, the download starts.

However, at least as soon as the download starts, the high amount of data which has to be conveyed to the user equipment via the air interface then causes the UTRAN to configure the user equipment for receiving data via the HS-DSCH. This configuration is for example done by means of an RRC message called RADIO BEARER RECONFIGURATION, which the SRNC sends to the user equipment in step S40 of FIG. 4.

FIG. 4 shows a flow-chart depicting a configuration of the receiving station by UTRAN and performing a quality of service control for a download of data from a transmitting station to a receiving station. After sending the RADIO BEARER RECONFIGURATION message in step S40, the user equipment is configured to receive the HS-DSCH (step S41). For example, the user equipment may be informed about the scrambling code and the channelization codes to be used for transmission via the HS-DSCH, as well as about the RLC settings necessary for data transmission via the HS-DSCH, the logical channels used for transmission of the data and the Radio Bearer Identity.

As soon as the RRC layer has received the RADIO BEARER RECONFIGURATION message, it takes the necessary local configuration actions, i.e. configures the physical layer, the medium access control layer (MAC layer) and the RLC layer. With respect to the configuration of the RLC layer, this means that the user equipment's RLC entity, which will be in charge of processing the download data received on the logical channel(s) configured for this, is informed that it should, as soon as its reception buffer occupancy reaches a certain maximum causing PDU loss, indicate to the physical layer that the latter should issue a STOP command to the sending NodeB.

The UTRAN expects, from the user equipment, a reply to the configuration message and this reply is in the considered case the RADIO BEARER RECONFIGURATION COMPLETE message, which carries, for example, security related data. For the purpose of providing the quality of service attribute “HS-DSCH with flow-control” to the relevant network nodes, this message is, according to an exemplary embodiment of the present invention, supplemented by a list of logical channels, for which the flow control should apply, i.e. the logical channels, which carry packets of the data stream which the user equipment should be able to throttle, if necessary. In step S42, the RADIO BEARER RECONFIGURATION COMPLETE message is transmitted to the SRNC, but the information related to the quality of service attribute “flow control” has to be known in the NodeB, since this is the node, which reacts to the STOP command, in order to provide a really fast flow-control. Furthermore, it may anyway be required for the SRNC to configure also the very NodeB for sending data to the user equipment via the HS-DSCH, whether flow-control is applied or not. Therefore, the 3GPP standard prescribes a message to be sent from the SRNC, for example via a DRIFT RNC, to the NodeB, in order to reconfigure an existing radio link. This message is called RADIO LINK RECONFIGURATION PREPARE according to “TS25.433 3^{rd} Generation Partnership Project; Technical Specification Group Radio Access Network; UTRAN lub Interface NBAP Signalling” and “TS25.423 3^{rd} Generation Partnership Project; Technical Specification Group Radio Access Network; UTRAN Iur Interface RNSAP signalling”, which are hereby incorporated by reference.

Transmission of this RADIO LINK RECONFIGURATION PREPARE message may be performed in step S43. In order to make the NodeB aware of the QOS attribute “HS-DSCH with flow-control”, this message is then supplemented by a list of logical channels of the corresponding Radio Bearer, which the NodeB should throttle in case it receives a STOP command by the user equipment. Therefore, the NodeB has to read the MAC-header of the received PDUs, which MAC-header contains the logical channel identifier (step S44). In step S45, the NodeB receives a STOP command from the user equipment. After that, based on the list of logical channels to throttle, the NodeB can then avoid sending PDUs of these logical channels via the HS-DSCH (step S46).

Therefore, no further data packet transmission is performed via the logical channels on the list without involving the admission control function in the network, thus simplifying network implementation.

A different implementation is described in steps S47 to S50, in which the NodeB is made aware of the PDUs which should not be sent after a STOP command is received. This is performed as follows: In step S47, the SRNC tags the PDUs of the respective logical channels, which the NodeB should be able to throttle, before sending them to the NodeB. In step S48, the SRNC transmits the tagged PDUs to the NodeB. Then, for example because the user equipment found out that it runs short of memory for storing a packet received via a logical channel mapped to the HS-DSCH, the user equipment transmits a STOP command to the NodeB in step S49. Any PDU with this tag, which the NodeB receives, is a PDU, which the NodeB does not consider for further transmission via the HS-DSCH after the STOP command has been received from the user equipment. Therefore, the transmission of tagged PDUs is blocked in step S50.

As may be seen from the above, the signalling approach does not only hold for the “absolute” edge of the network. As long as the user equipment exchanges messages with a particular network node, a quality of service attribute may easily be added for the path-segment, which terminates in this network node.

FIG. 5 shows a further schematic representation of an exemplary embodiment of a method according to the present invention. The receiving station or user equipment (RS/UE) transmits a first configuration message to the first network node (N1) during a configuration procedure. This first configuration message comprises a first quality of service attribute (1.QOSA). After receiving the first quality of service attribute (together with the first configuration message) the first network node N1 performs a second quality of service operation (2.QOSO) on the basis of the received first quality of service attribute. This second quality of service operation may comprise a tagging of a data packet, if the data packet is transmitted via a second logical channel of the group of second logical channels identified on the basis of the first quality of service attribute. In case, the data packet got tagged because it is transmitted via one of the listed second logical channels, a second quality of service attribute (2.QOSA) is transmitted from the first network node to the second network node (N2). This second quality of service attribute may comprise a request to the second network node for “HS-DSCH with flow-control”. As soon as the second network node receives a STOP command from the receiving station, the second network node performs the first quality of service operation (1.QOSO). This first quality of service operation performed by the second network node comprises a blocking of the tagged data packet.

Furthermore, according to another exemplary embodiment of the present invention, the second quality of service operation performed by the at least one first network node may comprise a transmission of a second quality of service attribute on the basis of the first quality of service attribute from the at least first network node to the second network node, wherein the second quality of service attribute comprises an identification of the group of second logical channels of the plurality of logical channels. After receiving the STOP command from the user equipment or receiving station, the first quality of service operation is performed by the second network node. This first quality of service operation comprises a blocking of the data packet, if the data packet is transmitted via a logical channel identified by the list of second logical channels. Advantageously, the second quality of service attribute is added to a second configuration message transmitted from the at least one first network node to the second network node during a second configuration procedure.

By transmitting the first quality of service attribute or the second quality of service attribute as part of a first or second configuration message (wherein the configuration messages have to be transmitted in any case), the signalling data traffic, especially the uplink data traffic, may be efficiently reduced.

FIG. 6 shows a communication system according to an exemplary embodiment of the present invention. The communication system comprises a receiving station or user equipment 601, a transmitting station 609, which, for example, may be a data server for audio files, or a mobile terminal, and a computer with a data processor 603. The communication system is part of a network, which comprises a plurality of network nodes, such as first network node N1 604 and second network node N2 602. The data processor 603 is linked to the second network node 602 via communication link 608. Furthermore, the data processor is used for executing a software program for performing quality of service control for a data transmission from the transmitting station to the receiving station in the network or for performing a transmission of a first quality of service attribute corresponding to a first quality of service operation for a data transmission in a network comprising network nodes N1 604 and N2 602. The transmission of a data packet from the transmitting station 609 to the receiving station 601 may be performed via communication links 610, 606 and 607. The data packet may be first transmitted to the first network node 604 via communication link (such as a wireless communication link) 610 and then, via communication link 606 to the second network node 602. The second network node 602 may be triggered from the receiving station 601, for example by the transmission of a STOP command during communication link 607, to perform a flow-control for data transmission via the High Speed Downlink Shared Channel in UMTS. The receiving station 601 depicted in FIG. 6 may be adapted for transmitting a first quality of service attribute to the at least one selected first network node 604 of the plurality of network nodes of the network via communication links 605, 611.

It should be noted, that transmission of the first quality of service attribute may, according to an exemplary embodiment of the present invention, be performed via the second network node 602 (as may be the case in, e.g., an UMTS network configuration, where the first network node may correspond to an RNC and the second network node may correspond to a Node B). However, in networks with an architecture other than the current UMTS network architecture, the transmission of the first quality of service attribute may also be performed directly from the receiving station 601 to the at least one selected first network node 604 via communication link 612. Furthermore, the second network node 602 is adapted for performing a first quality of service operation on the basis of the first quality of service attribute received in the first network node 604.

After having received the first quality of service attribute from the receiving station 601, the first network node 604 performs a second quality of service operation and transmits a second quality of service attribute to the second network node 602 via communication link 606. According to an exemplary embodiment of the method according to the present invention, this second quality of service attribute (which, advantageously, may be transmitted together with a second configuration message) comprises an identification of a group of second logical channels of the plurality of logical channels inside the network, which have to be blocked after receiving a STOP command from the receiving station 601 in the second network node 602.

The data processor 603 is adapted to perform an operation according to exemplary embodiments of the present invention when a computer program according to exemplary embodiments of the present invention is executed on the data processor 603.

It should be noted, however, that not only the second network node 602 may be linked to a data processor, but other network nodes, such as the first network node 604, or the transmitting station 609, or the receiving station 601, may be linked to, or comprise, data processors (which are not shown in FIG. 6) for performing respective operations.

The present invention described above may, for example, be applied in the field of wireless communication networks. However, the present invention may also be applied in the field of other communication networks, such as, for example, glass fibre communication networks.

Advantageously, according to an exemplary embodiment of the present invention, a quality of service attribute is only transmitted to a selected number of network nodes at the edge of the network. The selected (and limited) number of network nodes perform a quality of service operation which has been triggered by a receiving station. Therefore, a quality of service attribute is not transmitted to the admission control functions of all possible path-segments, i.e. on all network levels. Advantageously, this may result in less data traffic and in an improved implementation, since less different network node types are affected, and an improved standardization process, since fewer working groups have to be involved. Advantageously, according to an exemplary embodiment of the present invention, a quality of service attribute may be added to an obligatory configuration message, thus even further reducing the data traffic.

It should be noted, that the term “comprising” does not exclude other elements or steps and the “a” or “an” does not exclude a plurality and that a single processor or system may fulfil the functions of several means recited in the claims.

It should also be noted, that any reference signs in the claims shall not be construed as limiting the scope.

1. Method of performing a quality of service control for a data transmission from a transmitting station (609) to a receiving station (601) in a network, the network comprising a plurality of network nodes (602, 604), the method comprising the steps of:
transmitting a first quality of service attribute and a first configuration message from the receiving station (601) to at least one selected first network node (604) of the plurality of network nodes (602, 604) during a configuration procedure; and
performing a first quality of service operation by one second network node (602) of the plurality of network nodes (602, 604) on the basis of the first quality of service attribute received in the at least one selected first network node (604);
wherein the first configuration message comprises the first quality of service attribute.

2. The method according to claim 1, wherein the network comprises a plurality of logical channels; wherein the data is transmitted as data packet; wherein the data packet is transmitted via at least one first logical channel of the plurality of logical channels; wherein the first quality of service attribute comprises an identification of a group of second logical channels of the plurality of logical channels; and wherein the first quality of service attribute is applied to the group of second logical channels in form of the first quality of service operation performed by the second network node.

3. The method according to claim 1, wherein the first quality of service operation is triggered by a command transmitted from the receiving station (601) to at least one of the first and second network nodes.

4. The method according to claim 2, wherein the first quality of service attribute corresponds to a request for flow control of the data packet transmission.

5. The method according to claim 2, wherein the at least one first network node (604) performs a second quality of service operation on the basis of the first quality of service attribute before the first quality of service operation is performed by the second network node.

6. The method according to claim 5, wherein the second quality of service operation performed by the at least one first network node (604) comprises a tagging of the data packet, if the data packet is transmitted via a second logical channel of the group of second logical channels; and wherein the first quality of service operation performed by the second network node comprises a blocking of the tagged data packet.

7. The method according to claim 5, wherein the second quality of service operation performed by the at least one first network node (604) comprises a transmission of a second quality of service attribute on the basis of the first quality of service attribute from the first network node (604) to the second network node; wherein the second quality of service attribute comprises the identification of the group of second logical channels of the plurality of logical channels; and wherein the first quality of service operation performed by the second network node comprises a blocking of the data packet, if the data packet is transmitted via a second logical channel of the group of second logical channels.

8. The method according to claim 7, wherein the at least one first network node (604) transmits a second configuration message to the second network node during a second configuration procedure; and wherein the second configuration message comprises the second quality of service attribute.

9. The method of claim 1, wherein the method is applied for data transmission via the High Speed Downlink Shared Channel in UMTS.

10. A method of transmitting a first quality of service attribute corresponding to a first quality of service operation for a data transmission, the data transmission being performed from a transmitting station (609) to a receiving station (601) in a network, the network comprising a plurality of network nodes (602, 604), the method comprising the step of: transmitting a first configuration message from the receiving station (601) to at least one selected first network node (604) of the plurality of network nodes (602, 604) during a configuration procedure; wherein the first configuration message comprises the first quality of service attribute corresponding to a first quality of service operation by one second network node (602) of the plurality of network nodes (602, 604).

11. The method according to claim 10, wherein the at least one selected first network node (604) transmits a second configuration message to the second network node during a second configuration procedure; and wherein the second configuration message comprises a second quality of service attribute.

12. Communication system for performing a quality of service control for a data transmission from a transmitting station (609) to a receiving station (601) in a network, the network comprising a plurality of network nodes (602, 604), wherein the receiving station (601) is adapted for transmitting a first quality of service attribute to at least one selected first network node (604) of the plurality of network nodes; and wherein one second network node (602) of the plurality of network nodes (602, 604) is adapted for performing a first quality of service operation on the basis of the first quality of service attribute received in the at least one selected first network node (604).

13. Communication system for transmitting a first quality of service attribute corresponding to a first quality of service operation for a data transmission, the data transmission being performed from a transmitting station (609) to a receiving station (601) in a network, the network comprising a plurality of network nodes (602, 604), wherein the receiving station (601) is adapted for transmitting a first configuration message to at least one selected first network node (604) of the plurality of network nodes (602, 604) during a configuration procedure; and wherein the first configuration message comprises the first quality of service attribute corresponding to a first quality of service operation by one second network node (602) of the plurality of network nodes (602, 604).

14. Receiving station (601) for a communication system for performing a quality of service control for a data transmission from a transmitting station (609) to the receiving station (601) in a network, the network comprising a plurality of network nodes (602, 604), wherein the receiving station (601) is adapted for transmitting a first quality of service attribute to at least one selected first network node (604) of the plurality of network nodes (602, 604); and wherein one second network node (602) of the plurality of network nodes (602, 604) is adapted for performing a first quality of service operation on the basis of the first quality of service attribute received in the first network node (604).

15. Receiving station (601) for transmitting a first quality of service attribute corresponding to a first quality of service operation for a data transmission, the data transmission being performed from a transmitting station (609) to the receiving station (601) in a network, the network comprising a plurality of network nodes (602, 604), wherein the receiving station (601) is adapted for transmitting a first configuration message to at least one selected first network node (604) of the plurality of network nodes (602, 604) during a configuration procedure; and wherein the first configuration message comprises the first quality of service attribute corresponding to a first quality of service operation by one second network node (602) of the plurality of network nodes (602, 604).

16. Software program for performing a quality of service control for a data transmission from a transmitting station (609) to a receiving station (601) in a network, the network comprising a plurality of network nodes (602, 604), wherein the computer program causes a data processor to perform the following operation when the computer program is executed on the data processor: performing a first quality of service operation related to one second network node (602) of the plurality of network nodes (602, 604) on the basis of a first quality of service attribute transmitted from the receiving station (601) to at least one selected first network node (604) of the plurality of network nodes (602, 604).

17. Software program for performing a transmission of a first quality of service attribute corresponding to a first quality of service operation for a data transmission, the data transmission being performed from a transmitting station (609) to a receiving station (601) in a network, the network comprising a plurality of network nodes (602, 604), wherein the computer program causes a data processor to perform the following operation when the computer program is executed on the data processor: performing a transmission of a first configuration message from the receiving station (601) to at least one selected first network node (604) of the plurality of network nodes (602, 604) during a configuration procedure; wherein the first configuration message comprises the first quality of service attribute corresponding to a first quality of service operation by one second network node (602) of the plurality of network nodes (602, 604).
